(19) United States
(12) Patent Application Publication
(10) Pub. No.: US 2021/0264812 A1
(43) Pub. Date: Aug. 26, 2021

(54) LANGUAGE LEARNING SYSTEM AND METHOD

(71) Applicant: REALLINGUA INC., Ypsilanti, MI (US)

(72) Inventor: Keith Phillips, Ann Arbor, MI (US)

(21) Appl. No.: 17/317,316

(22) Filed: May 11, 2021

Related U.S. Application Data
(63) Continuation-in-part of application No. 15/786,567, filed on Oct. 17, 2017.

(51) Int. Cl. G09B 19/06; G09B 5/06; G10L 15/22; G10L 15/183; G06F 40/58; G06F 40/166; G06F 40/289; G06F 40/109; G10L 15/30

(52) U.S. Cl. CPC G09B 19/06; G09B 5/06; G10L 15/22; G10L 15/183; G09B 7/02; G06F 40/166; G06F 40/289; G06F 40/109; G10L 15/30; G06F 40/58

(57) ABSTRACT

The present invention is a language learning method and system. The present invention records a conversation by two native-speakers in a target language. The conversation is transcribed and translated. The transcribed and translated versions are both segmented into snippets that last between thirty (30) seconds and five (5) minutes. A concordance is created from the transcribed segmented conversation. A pareto distribution is created from the concordance. A set of high-frequency, non-trivial words and phrases are defined by the pareto distribution. A language learning application teaches a student the target language by presenting language learning exercises to the student which concentrate on the high-frequency, non-trivial words.

### CROSS REFERENCE TO RELATED APPLICATIONS

This application is a continuation-in-part of U.S. patent application Ser. No. 15/786,567, filed Oct. 17, 2017, the contents of which are herein incorporated by reference in their entirety.

### FIELD OF INVENTION

This invention relates to the class of education and demonstration and one or more sub-classes related to language. Specifically, this invention relates to a foreign language learning system and method.

### BACKGROUND OF INVENTION

There are approximately 7000 living languages extant today. Of those, approximately twenty-six languages have 50 million or more total speakers, according to the 2017 edition of ETHNOLOGUE: LANGUAGES OF THE WORLD, published by SIL International: Mandarin Chinese, English, Hindustani (Hindi/Urdu), Spanish, Arabic, Malay, Russian, Bengali, Portuguese, French, Hausa, Punjabi, Japanese, German, Persian, Swahili, Telugu, Javanese, Wu Chinese, Korean, Tamil, Marathi, Yue Chinese (Cantonese), Turkish, Vietnamese, and Italian (“Most Spoken Languages”).

Learning a new language with conventional techniques is a time-consuming task. The United States Department of State estimates that it takes 4400 hours to become proficient in a new language. The Common European Framework of Reference for Language (“CERF”) estimates that, between Guided Learning Hours (“GLH”) and personal study hours, it takes 1000-1200 hours to achieve proficiency in a new language. The American Council on Teaching Foreign Language (“ACTFL”) estimates that it takes 960 hours, between GLH and personal study hours, to achieve mid-level proficiency in a Romance language (e.g., French, Spanish, and Portuguese). According to the American Defense Language Institute, where the United States' Central Intelligence Agency teaches officers and agents foreign languages, between 1500 and 4000 hours are needed to learn a new language, when accounting for both instructional time and study time.

The time-commitment required to achieve proficiency inhibits learning and reduces success rates. Many students abandon a new language program shortly after joining, because the time-commitment needed to achieve proficiency is overwhelming. Moreover, the substantial time-commitment required to learn a language makes it impractical for people who are travelling for business or pleasure to learn a language prior to their trip. The lead-time required to learn a new language using traditional methods creates a significant disincentive to learning a new language when travel is only weeks or months in the future.

Traditional methods are abstract, by design, starting with grammar and declensions rather than conversation. By focusing on the abstract constructs of language, traditional methods tend to inhibit language acquisition. Additionally, teaching abstract concepts such as grammar and declensions increases the raw volume of information that must be mastered prior to a student becoming fluent. Another complaint about traditional methods for teaching foreign language is that they teach many concepts that are of dubious use. For example, teaching one about the post office in the internet age is often a waste of time.

Newer methods, such as interactive immersion, use computer exercises in an attempt to speed language acquisition. Interactive immersion allows a user to interact with various multi-person scenes, while being presented with the language corresponding to the scene from each person's perspective. Unfortunately, interactive immersion still depends heavily on teaching grammar and contextualizing conversations in an abstract manner.

When humans learn their first language, they are not immediately taught grammar and declensions. Additionally, toddlers acquiring language are not given artificial abstractions to contextualize grammar. Research data shows that people learn their first language by natural repetition. Language is assimilated in small segments, called snippets, usually between one and three minutes in length. In practice, the lower limit will be around thirty (30) seconds and the upper limit will be five (5) minutes. People learn the most commonly used words first and start speaking when they can use common words in a logical thought.

No current method replicates the natural language acquisition method of humans: namely, repetitively presenting the most common words in a variety of contexts to allow the student to master the most important words in a language. A pareto analysis of word-use shows that 80% or more of the content of a native speaker of a language is encompassed in as little as 1,000 (one thousand) words (“high-use pareto”). It is this aspect of the language-acquisition Pareto-Effect that allows toddlers to acquire language so quickly. By focusing a system and method on the content of the high-use pareto, students learn language more quickly in a much more natural, familiar, and organic fashion.

### SUMMARY OF THE INVENTION

This summary is intended to illustrate and teach the present invention, and not limit its scope or application. The present invention is a system and method for language learning. The target language is the language that is being learned. The base language is the language the student speaks natively. The system and method for language learning can be used to teach a student who speaks a Most Spoken Language as a base language a different Most Spoken Language as a target language. Additionally, the system and method for language learning can be used to teach a student who speaks any of the approximately 7,000 languages as a base language another one of the approximately 7,000 languages as a target language.

The system and method for language learning starts with a conversation involving a plurality of persons (“Native-speakers”) conversant in a target language. The conversation is not scripted, but guidelines are given to the Native-speakers. The guidelines identify topics that should be discussed by the Native-speakers, without dictating the content of the discussion. At least one such conversation of Native-speakers is recorded and captured on a server and database. A server is a collection of processors and associated circuitry upon which a software instruction set can executed. A database is a collection of memory elements which interoperates with the server and software instruction set. The server and database may be physically separated, in which case the server communicates with the remote database. The server and database can also be physically connected or be resident in the same assembly. The database may be internal to the server or it may be external to the server, such as a cloud repository. In this application, the cloud refers to a plurality of vendorized memory and server elements that are accessible to a user via the internet.

The at least one recorded conversation is transcribed in the target language and translated into a base language. The base language is a language with which the user of the present invention, a student, is familiar. Once the at least one conversation is transcribed and translated, both versions of the conversation are segmented into logical blocks of between one and three minutes in length. In no event should the logical blocks be less than 30 (thirty) seconds in duration, nor more than five minutes in duration. The at least one transcribed and segmented conversation is used to create a concordance. The concordance is an alphabetical list of the non-trivial words and phrases (i.e. the words and phrases that give meaning to the conversation) present within the at least one segmented and transcribed target language conversation, with reference to the passage(s) where the word or phrase occurred. The target language concordance is used to create a pareto distribution of the frequency with which words and phrases are used. The words and phrases are rank ordered in the pareto distribution. A pre-defined threshold is established. The pre-defined threshold is either a word count or a percentage. The words or phrases that are above the pre-defined threshold are referred to as the high-frequency words and phrases.

The pareto distribution, concordance, segmented conversations, translated conversations, and transcribed conversations are used to identify and create the content. The content is presented to the student emphasizing the high-frequency words and phrases. This analytics process outputs a method of language learning called the captured content.

The method of language learning is used within a system. The system includes a server and database on which the language learning method resides; a user electronic device; a means for communicating between the user electronic device and the server and database; and the captured content. A user interacts with the language learning method using an application resident on the user's electronic device, or via an internet-based application, such as a web page. The user's electronic device can be a cellphone, tablet, computer, or wearable electronic (e.g., smart watch). The user's electronic device has a processor, a memory element with non-transitory computer readable medium, an input means, a communication means, for example an antenna, transmitter, or transceiver, allowing it to send and receive information. The user's electronic device is capable of connecting to the internet, either directly (e.g., an ethernet cable or Wi-Fi) or through a communications network, such as a cellular network.

The student is exposed to the captured content, emphasizing the transcribed and segmented recordings of actual Native-speakers. The frequency with which a student encounters a word or phrase is based on the pareto distribution of the captured content. The student learns aural skills by listening to the transcribed segmented recordings in a 1-2-1 sequence (one time before completing associated practice activities, two times during the practice activities, and one time following the practice activities).

Written practice activities are also presented to the student. The written practice activities are conducted in the target language, and involve both vocabulary and grammar activities. Written practice activities include, but are not limited to, word matching between the target and base language, partial word completion in the target language, fill-in-the-blank, and multiple choice. The vocabulary in the practice activities are presented with a frequency that approximates the pareto distribution. Practice activities also include oral skills, which are built by repeating select portions of the segmented, transcribed recordings. The written and oral portions of the practice activities prepare students to practice the target language by building cognitive skills, focusing on the words that are most used in the target language. The student's cognitive and language production skills are built using words, phrases, and grammatical segments from the transcribed recordings of the target language using contextual completion and individual modification. Contextual completion means filling-in phrases or sentences with logical grammar from the target language using the context presented. Individual modification means completing information in a phrase or sentence using personal information. This would include such activities as completing phrases with language appropriate to the student's gender.

In order to access the application, the student logs in on their electronic device. The student is presented with a plurality of learning modules, and may open the module of their choosing. The application begins the module either from the beginning or from where the student left off during a previous session, whichever is appropriate. The student works on the activity until completion or until the student disengages. The application records the student's answers. The application has service interrupts in all modules, allowing the student to exit the application at any time.

The application tracks, guides, and rewards the student's progress by calculating the student's completion and success rates. By analyzing the student's progress, the application suggests activities to be repeated.

The captured content is the translated and segmented conversations, wherein the frequency of presentation is based on the analytics of the concordance and pareto distribution. The captured content is hosted on the server and database. The captured content is presented to the student using a user interface (UI), creating a user experience (UX).

The presentation (UI, UX) is made to the student's mobile device or computer. The student's electronic device communicates with the server and database via a communication system using the internet, cellular service, or a combination of both. The student's electronic device is communication enabled through the internet and/or through a cellular network.

The captured content is presented (UI, UX) to the student's electronic device using an application. The captured content is processed so that the high-frequency words and phrases are highlighted. The high-frequency words and phrases are defined by the pareto distribution. The highlighting can take many forms, including, but not limited to: displaying the high-frequency word with bold text; changing the color of the high-frequency word; creating a highlight on the background adjacent to the high-frequency word; and italicizing the high-frequency word.

The application calculates success rates and exposure during a session and overall. The user's success rates and exposure are processed and shown to the user through the UI, UX. The user success rates are processed with a machine-learning algorithm via natural language processing (“NLP”). The processed success rates are fed to a module of the application, that adjusts the captured content that is presented to the student based off of the student's progress. The content adjusting can take one of two implementations. The exposure rate of particular high-frequency words and phrases to the user can be increased or decreased based off the success rate. For example, as the student gains proficiency, the application will reduce presentation of the highest frequency words, provided the student has cognitive understanding of the words. Words and phrases with a lesser frequency will then be added into the rotation of the captured content that is presented to the student. The new exposure rates can then be fed back to the captured content. The highlighting of high-frequency words and phrases can also be modified to emphasize certain content to the user. For example, if a student repetitively misses a particular word or phrase, the highlighting can be both bolded and presented in a different color of text. The new highlighting scheme can be fed back to the captured content.

The application can be written in a traditional server and client manner, or it can be written so that the application is totally resident on the cloud and a student merely accesses the application through web pages on a web-portal. As the particular architecture of the software components is not part of the claimed invention, it is left to those skilled in the arts to select the most appropriate method for their particular implementation.

Another aspect of the present invention is directed to a computer-implemented language learning method comprising receiving a recorded conversation, which complies with a guideline document, between at least two individuals fluent in the target language, wherein the individuals in the recorded conversation are referred to as Native-speakers, and wherein the guideline document contains unscripted conversation topics in a target language, without reference to specific words or phrases; wherein the recorded conversation is comprised of a plurality of non-trivial words and phrases; and

wherein the non-trivial words are those that give meaning to the recorded conversation; transcribing, using a first one or more application program interfaces, the recorded conversation in the target language; translating, using a second one or more application program interfaces, the recorded conversation into a base language; segmenting, using a combination of time-stamp metadata and a natural language processing text segmentation algorithm, the transcribed and translated versions of the recorded conversation, into snippets, so that each snippet is composed of a logical block of language of the recorded conversation, lasting about thirty seconds to about five minutes in duration and containing a plurality of non-trivial words and phrases, and wherein the snippet is comprised of the logical block of language from the recorded conversation, the transcribed text in the target language corresponding to the logical block of language from the recorded conversation, and the translated text in the base language corresponding to the logical block of language from the recorded conversation; creating a target language concordance of the recorded conversation comprising: generating an alphabetical listing, using a sort-function algorithm, of the non-trivial words and phrases of the target language contained in the recorded conversation, and generating a key-value collection in which each key represents a word or a phrase in the alphabetical listing and each value represents one or more references to locations in one or more segments in which the word or phrase occurred within the recorded conversation, the transcribed text, and the translated text; generating a Pareto distribution from the concordance, wherein the Pareto distribution identifies the frequency with which the non-trivial words and phrases appear in the recorded conversation; wherein the non-trivial words and phrases are rank ordered in terms of frequency of occurrence; wherein a frequency threshold is defined for the Pareto distribution; and wherein the words appearing more often than the frequency threshold are referred to as high-frequency words and phrases; analyzing the snippets, using the Pareto distribution and concordance, to ascertain the snippets within which the high-frequency words and phrases occur most frequently; and presenting the snippets, within which the high-frequency words and phrases occur most frequently, on a graphical user interface of a computing device of a student fluent in the base language but not the target language.

In some embodiments, the method further includes logging per API accuracy statistics for the one or more APIs for transcription that are then used to train one or more machine learning models to select a most effective API for future transcription to continuously improve transcription accuracy over time.

In some embodiments, the method further includes merging the target language concordance for the recorded conversation with a broader concordance for an entire target language dataset to account for conversational bias on a per recorded conversation basis.

Another aspect of the present disclosure is directed to a language learning system comprising: at least one user electronic device, comprising a processor, a memory element that has a first non-transitory computer readable medium, a graphical user interface communicatively coupled to the processor, and a transceiver allowing the at least one user device to send and receive information; a server comprising a server memory element that has a second non-transitory computer readable medium, a server processor, and a server transceiver, wherein the server is communicatively coupled to the at least one user electronic device; at least one computer readable instruction set, called an application, configured to run on one or both of the at least one user electronic device or the server, such that one or both of the processor or the server processor is configured to execute the instruction set comprising: receiving a recorded conversation, which complies with a guideline document, between at least two individuals fluent in the target language, wherein the individuals in the recorded conversation are referred to as Native-speakers, and wherein the guideline document contains unscripted conversation topics in a target language, without reference to specific words or phrases; wherein the recorded conversation is comprised of a plurality of non-trivial words and phrases; and wherein the non-trivial words are those that give meaning to the recorded conversation; transcribing, using a first one or more application program interfaces, the recorded conversation in the target language; translating, using a second one or more application program interfaces, the recorded conversation into a base language; segmenting, using a combination of time-stamp metadata and a natural language processing text segmentation algorithm, the transcribed and translated versions of the recorded conversation, into snippets, so that each snippet is composed of a logical block of language of the recorded conversation, lasting about thirty seconds to about five minutes in duration and containing a plurality of non-trivial words and phrases, and wherein the snippet is comprised of the logical block of language from the recorded conversation, the transcribed text in the target language corresponding to the logical block of language from the recorded conversation, and the translated text in the base language corresponding to the logical block of language from the recorded conversation; creating a target language concordance of the recorded conversation comprising: generating an alphabetical listing, using a sort-function algorithm, of the non-trivial words and phrases of the target language contained in the recorded conversation, and generating a key-value collection in which each key represents a word or a phrase in the alphabetical listing and each value represents one or more references to locations in one or more segments in which the word or phrase occurred within the recorded conversation, the transcribed text, and the translated text; generating a Pareto distribution from the concordance, wherein the Pareto distribution identifies the frequency with which the non-trivial words and phrases appear in the recorded conversation; wherein the non-trivial words and phrases are rank ordered in terms of frequency of occurrence; wherein a frequency threshold is defined for the Pareto distribution; and wherein the words appearing more often than the frequency threshold are referred to as high-frequency words and phrases; analyzing the snippets, using the Pareto distribution and concordance, to ascertain the snippets within which the high-frequency words and phrases occur most frequently; and presenting the snippets, within which the high-frequency words and phrases occur most frequently, on the graphical user interface of the at least one user electronic device of a student fluent in the base language but not the target language.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 is a high-level communication system flow of the present invention.

FIG. 2 is a high-level language-capture flow of the present invention.

FIG. 3 shows a high-level timeline of the present invention's learning process.

FIG. 4 is high-level flow chart of the present invention.

FIG. 5 is a high-level system flow chart.

The illustrated embodiments are merely examples and are not intended to limit the disclosure. The schematics are drawn to illustrate features and concepts and are not necessarily drawn to scale.

### DETAILED DESCRIPTION OF THE DRAWINGS

The following descriptions are not meant to limit the invention, but rather to add to the summary of invention, and illustrate the present invention, a system and method for language learning. The system and method for language learning presented with the drawings of this specification is but one potential embodiment. Those skilled in the art are able to take the disclosure provided herein to create additional embodiments.

As used herein, recording can mean streaming to and then persisting on the server, capturing locally with a digital or analog recording device, etc. Recording may be essentially any means by which spoken language can be captured or converted to a digital medium for further processing, analysis, and transformation.

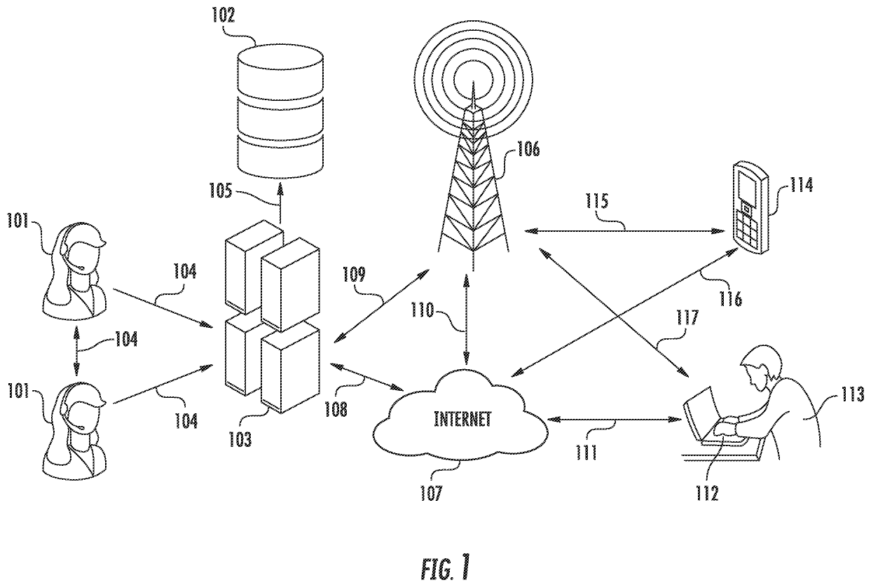

The system and method for language learning can be used to teach a student who speaks a base language a different than a target language. In its most general form, the system and method for language learning can be used to teach a student who speaks any of the approximately 7,000 languages as a base language another one of the approximately 7,000 languages as a target language. FIG. 1 is a high-level system flow-chart of the present invention 100, a system and method for language learning. The high-level communication flow-chart is accomplished with circuitry and software, which is a computer readable instruction set stored on a non-transitory, computer-readable medium. The circuitry and software enable the present invention 100.

The system and method for language learning 100 is intended to teach a target language to a non-native speaking student 113. The non-native speaking student's 113 language is referred to as the base language. The system and method for language learning 100 starts with a plurality of persons (“Native-speakers”) 101 conversant in a target language. Given the thousands of living languages in existence, a system for managing and matching native speakers is necessary to establish an adequate data source. For example, a native speaker may register with an application running on a server that communicates with a database. The database may store registrant information including languages spoken, fluency levels, regions or dialects spoken, geographic location, topics of interest, etc. Native speakers are then algorithmically matched based on attributes including language, dialect, geography, topics, etc. Based upon topics still needed to complete the data source for a given language, a scheduling system arranges meetings between the native speakers.

At least one conversation 119 of native-speakers 101 is recorded 104 and captured on a server 103. In some embodiments, the scheduling system may create a digital conference room (similar to a Zoom call or a Google Hangout) that has been pre-configured to stream and record the call. If the native speakers don't have access to computers and broadband, a digital recording device may be sent to them such that it can be mailed back for uploading to the server. The native-speakers are provided guidelines for the conversation, said guidelines emphasizing topics which should be discussed, rather than words or phrases that are to be used. As shown in FIG. 1, the server 103 communicates 105 with a database 102. The database 102 may be internal to the server 103 or it may be external to the server, such as a cloud repository, accessible to the student 113 via the internet 107.

For example, in some embodiments, the conversation is real-time streamed to the server, for example using an HTTP-based adaptive bitrate streaming communication protocol like HLS (HTTP Live Streaming), where server-side NLP-based analysis is done on the conversation to help assess conformance to the provided guidelines, so that the native speakers can receive feedback via recording conference room's graphical user interface as to topic conformance and completeness.

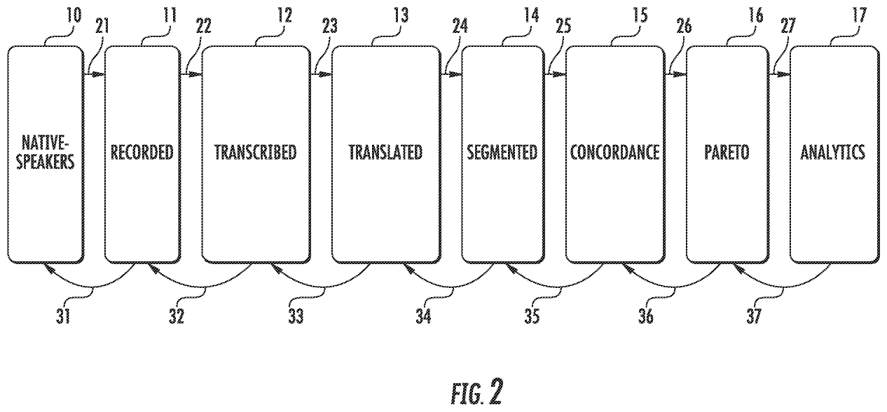

FIG. 2 shows the language-capture method flow-chart of the present invention 100. The native-speakers 101 conversation is transmitted 21 in a manner which allows it to be recorded 104. The at least one conversation is copied and transmitted 22, 23 in a manner which allows it to be transcribed 12 in the target language and translated 13 into the base language, by a transcription 12 module and a translation 13 module, respectively.

In some embodiments, the transcription module is a web service residing on the same server or on another server. The transcription module, invoked whenever a new recording is received, synchronously and in real-time, sends or streams the recorded audio file to 1-to-n speech-to-text APIs, such as AssemblyAI, Google Speech-to-Text, AWS Transcribe, or similar service, based upon documented language-specific capabilities and tested accuracies. In some instances, the module may use multiple APIs to arrive at the most accurate transcription. The transcriptions may be returned from the transcription API to the transcription module in an industry-standard, time-stamped caption/subtitle format such as SRT (SubRip text format), VTT (Web Video Text Tracks format), or the like.

In some embodiments, the transcription module may also log per-API accuracy statistics, that will teach a transcription ML model that may be trained to continuously improve translation accuracy and reduce translation cost by selecting the most effective translation APIs for future translations based upon past results for a given set of parameters, such as, for example, language, dialect, and topic. Accuracy scores fed to the model may be derived from third-party API provided confidence scores, combined with input from one or more reviewers or a plurality of reviewers that may provide quality assurance checks on the transcriptions. The translation module of some embodiments may be configured similar to the transcription module, as described above.

At this point, the conversation exists as both a recorded transcription 12 (target language) and a recorded translation 13 (base language). Once the at least one conversation is transcribed 12 and translated 13, both versions of the conversation are copied and transmitted to a segmentation module. 24 In some embodiments, the segmentation module is a web service residing on the same server or on another server. The segmentation module may use a combination of the time-stamp meta data returned from the transcription module and an NLP text segmentation algorithm to segment 14 the transcription and translation into logical blocks, or snippets, usually between one and three minutes in duration. In terms of its expression as a data structure, each segment may comprise the segment text and a range that indicates the location of the unique words and/or phrases in the recorded conversation. The range may comprise a starting character offset (number of characters from the beginning of the transcribed string) of the segment and optionally, its character length within the transcription.

In practice, the lower limit for the segments may be about thirty (30) seconds and the upper limit may be about five minutes. Such snippets or logical blocks are created and/or selected such that they may be presented to one or more users or learners, as described elsewhere herein.

Alternatively, or additionally, in some embodiments, determining a location of the unique words and/or phrases in the recorded conversation may include automatically tagging intervals of dialogue, for example every third line, every fourth line, every fifth line, every sixth line, every seventh line, etc. In some embodiments, tags may be revealed on transcription and translation within platform lessons, for example based on user action (e.g., user hovers cursor).

Alternatively, or additionally, an API is configured to connect an occurrence of a word and/or phrase with a line location in a written transcript. Such occurrence or location of the word and/or phrase may be automatically time stamped.

The transcribed 12 and segmented 14 conversation is copied and transmitted 25 in a manner which allows a concordance 15 to be created by a concordance module 15. In some embodiments, the concordance module is a web service residing on the same server or on another server. The concordance 15 created from the transcribed 12 and segmented 14 conversation is an alphabetical, unique list of the non-trivial words and/or phrases (i.e., the words and phrases that give meaning to the conversation) present within the segmented 14 and transcribed 12 target language conversation, with reference to the passage(s) to where the word and/or phrase occurred. The list of non-trivial words is derived by excluding trivial words. In contrast, one or more trivial words may be included in a phrase to retain meaning and structure. Non-limiting examples of trivial words include: articles, prepositions, interjections, conjunctions, and vocalized pauses from the segmented and transcribed target language conversation. The resulting list is then sorted in lexicographical order using a sort function, that employs a sorting algorithm such as Quicksort or similar algorithm. To build the map of references to passage(s) where the given words and/or phrases appear, the alphabetical list may be run through an algorithm that generates a key-value collection, with each entry (e.g., word or phrase) being keyed by a unique word and/or phrase in the alphabetized list and the value being a collection of references to segments in which each occurrence of the word appears within the transcription.

Alternatively, or additionally, in some embodiments, unique words and/or phrases are extracted to identify at least one occurrence of each word and/or phrase. Further, extraction may occur using natural language processing (NLP) such that a text-extractor (e.g., via an application program interface of API) may be used to identify unique words, and a phrase parser (e.g., via an API) may be used to identify phrases. NLP may be further configured to assess tone and/or sentiment of conversations and written text. Such tone and/or sentiment may indicate age appropriateness for the learner, and further identify whether the learning is understanding the meaning and/or context of the spoken phrases or words. In some embodiments, the NLP for extraction may be trained by setting one or more parameters to ignore one or more words, characters, and/or characteristics of words or phrases.

Alternatively, or additionally, word and/or phrase extraction may be performed using one or more machine learning models. For example, using a training dataset, the one or more machine learning models may be trained to identify non-trivial words in training dataset recordings and/or transcripts, such that when the machine learning model is fed an unknown dataset, the model is trained to identify non-trivial words. For example, the machine learning model may be trained via modification of application program interface (API) scripts to identify macro characteristics (e.g., nouns, verbs, adjectives, maculine/feminine form, singular/plural form, etc.) in unknown datasets that identify non-trivial words and/or phrases. In some embodiments, one or more machine learning models may be further, or alternatively, trained to identify word roots as opposed to full words, such that in an unknown transcription, the one or more machine learning models are configured to identify language constructs like conjugation (i.e., the variation of the form of a verb in an inflected language by which are identified the voice, mood, tense, number, and person).

Alternatively, or additionally, the concordance may me further trimmed to aggregate alternate forms of words so as to group words by their roots, effectively uniting alternate expressions of words regardless of their forms including plural, tense (e.g., past tense, future tense, subjunctive, etc.), contracted, conjugated, etc.

The target language concordance 15 is copied and transmitted 26 in a manner which allows a pareto distribution 16 to be created by a pareto distribution module 16. In some embodiments, the pareto distributions module is a web service residing on the same server or on another server. A pareto distribution 16 is a word-count frequency distribution, identifying which words in the transcribed 12 and segmented 14 target language conversation are most used. The target language concordance for the recorded conversation may then be merged in with the broader concordance for the entire language dataset so that the pareto distribution module may consider the new conversation in aggregate with all prior conversations, so as to not bias the broader statistical conversation with the situational circumstance of any one conversation (e.g., parents might talk about things in the context of children, whereas single people might talk more about things in the context of dating). The words and phrases are put in rank order, by occurrence, in the pareto distribution 16. The pareto distribution 16 is copied and transmitted 27 to an analytics 17 module.

The analytics module 17 receives data from the pareto distribution 37, 16; the concordance 36, 15; the segmented conversations 35, 15; the translated 34, 13 conversations; the transcribed 33, 12 conversations; and the recorded 32, 104 conversations of the native speakers 31, 101. In some embodiments, the analytics module is a web service residing on the same server or on another server. The analytics 17 module creates an interactive system and method 100 for a user/learner. For example, the analytics module 17 continuously updates lessons and/or a graphical user interface of a user device based on data received from the above-mentioned sources. Further, user input or feedback may be received by the analytics module 17 to alter or inform which lessons, words, and/or phrases are presented to the user or learner.

Lastly, assembling a script to provide to the learner words and/or phrases may include automatically generating and/or compiling a script that outputs words and/or phrases to the learner. Such output of words and/or phrases may be automatically randomized by the concordance module 15.

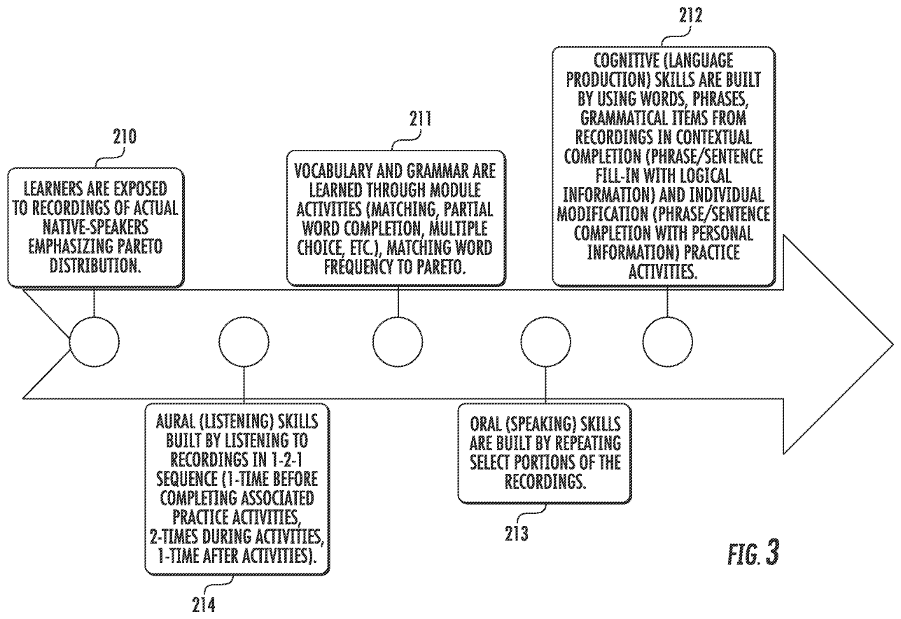

FIG. 3 is a high-level timeline of the learning method for a student 113.

Initially 210, the learners 113 are exposed to transcribed 12 segmented recordings 14 of actual native speakers 101 emphasizing the pareto distribution 16. Next 214, the student 113 builds aural skills by listening to the transcribed 12 segmented 14 recordings. The student 113 listens to the transcribed 12 segmented 14 recordings in a 1-2-1 sequence (one time before completing associated practice activities, two times during the practice activities, and one time following the practice activities).

The written portion of the practice activities 211 are vocabulary and grammar activities, conducted in the target language, such as matching, partial word completion, and multiple choice. The vocabulary in the practice activities 211 are presented in a frequency that matches the pareto distribution 16. Practice activities also include oral skills 213, which are built by repeating select portions of the recordings. The written portion 211 and oral portion 213 of the practice activities prepare students 113 to practice the target language by building cognitive skills 212. The student's 113 cognitive skills 212, or language production skills 212, are built using words, phrases, and grammatical segments 14 from recordings 104 in contextual completion and individual modification. Contextual completion means filling-in phrases or sentences with logical grammar from the target language using the context presented. Individual modification means completing phrase or sentence information using personal information.

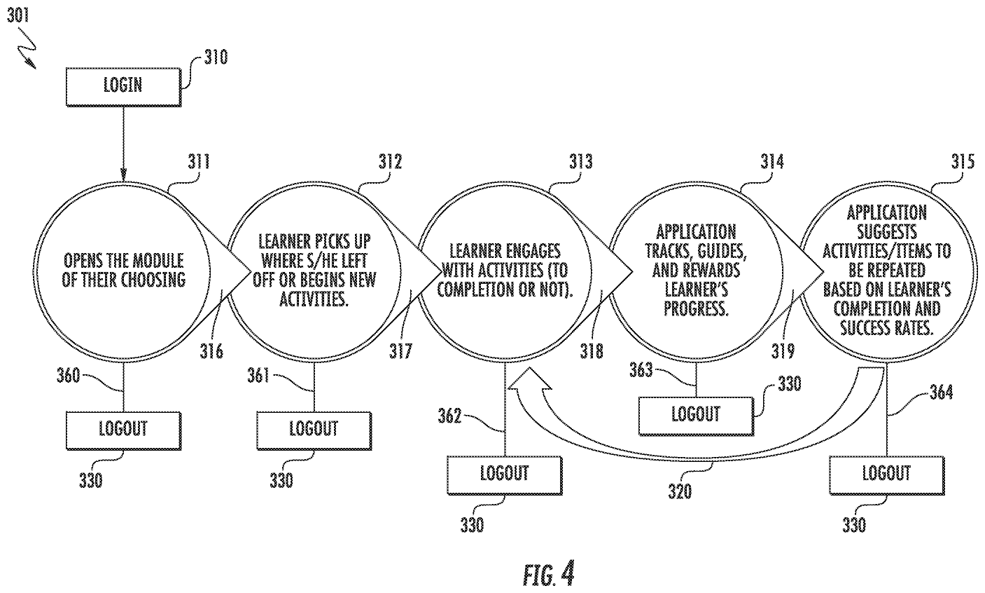

FIG. 4 is a high-level logic flow for a programmatic implementation 301 of the learning process for a student 113. The student 113 logs in 310. The student 113 is presented multiple modules, and may open the module of their choosing 311. The module opens 316 and either takes the student 113 to where the student 113 left off in the module during a previous session; or presents the student with an activity from the beginning of the module 312. The student 113 begins the activity where presented 317 and engages with the activity until completion or until the student 113 disengages 313. The application receives activity-based inputs 318 from the student 113, allowing the application to track, guide, and reward the student's progress 314. By analyzing 319 the student's 113 progress, based on the student's 113 individual completion and success rates, the application suggests activities to be repeated 315, 320. The programmatic implementation 301 of the system and method 100 has a plurality of service interrupts 360, 361, 362, 363, 364, allowing the user to stop the programmatic implementation 301 by logging out 330.

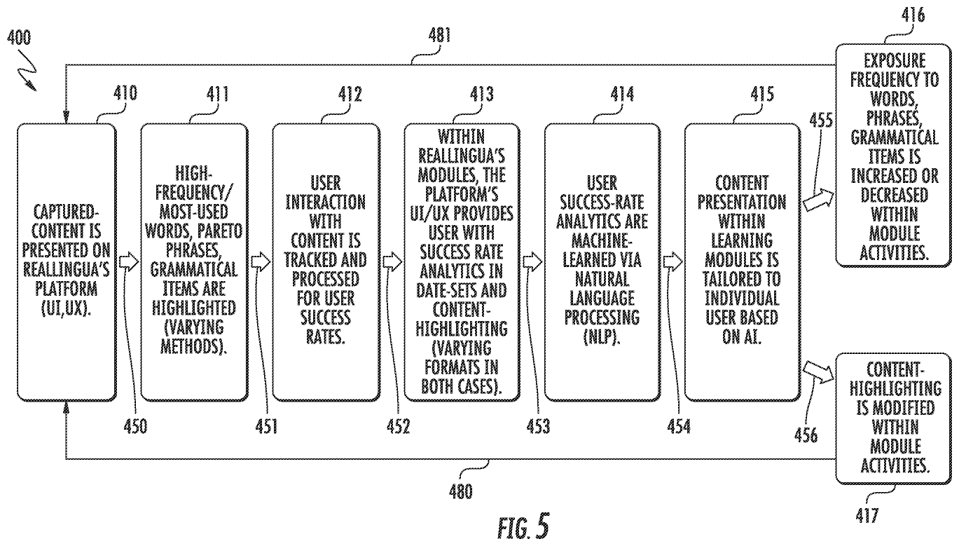

FIG. 5 is a high-level system 400 flow-chart. This discussion will also reference the high-level system communication flow of FIG. 1, language-capture method flow-chart of FIG. 2, and the high-level logic flow for a programmatic implementation 301 of FIG. 4. The captured content 410 is the translated 13 and segmented 14 conversations, presented based on analytics 17 of the concordance 15 and pareto distribution 16. The captured content 410 is hosted on a server 103 and database 102 and is presented to the student 113 using a user interface (UI), creating a user experience (UX). The presentation (UI, UX) is made via the programmatic implementation 301.

The presentation (UI, UX) is made to the student 113 on a mobile device 114 or computer 112. The student's 113 electronic device 114, 112 communicates 111, 115, 116, 117, 110, 109, 108 with the server 103 and database 102 via a public communication system 111, 115, 116, 117, 110, 109, 108, 107, 106 using the internet 107, cellular service 106, or a combination of both internet 107 and cellular service 106. The student's 113 electronic device 114, 112 is communication enabled 111, 115, 116, 117, 110, 109, 108, through the internet 107 and/or through a cellular network 106. Although not shown, the student's 113 electronic device can also be a tablet or a wearable electronic, such as a smart watch. The student's electronic device 114, 112 has a processor, a memory element with non-transitory computer readable medium, an input means (e.g., touch-responsive screen, buttons, sliders, etc.), a communication means (e.g., transceiver, transmitter, antenna, etc.) allowing it to send and receive information.

The captured content 410 is presented (UI, UX), using the programmatic implementation 301, to the student's 113 electronic device 112, 114. The captured content 410 is processed 450 so that the high-frequency words and phrases are highlighted 411. The high-frequency words and phrases are defined by the pareto distribution 16. A pre-defined threshold, being either a word count or a percentage, is defined. All of the words or phrases which exceed the pre-defined threshold are high-frequency words and phrases. If the threshold is a word-count, the invention can take anywhere from the 500 to 1000 most used words and phrases in the target language as high-frequency words and phrases. If the threshold is a percentage, the invention can take anywhere from the top 5% to top 25% of the most frequently used words and phrases as the high-frequency words and phrases. Assessment of top 1000 words and phrases per language sourced from data sources (e.g., dictionaries, blogs, news, social media, urban dictionary, Google search trends, etc.), all maintained in real-time, is not possible for a human to do or maintain with any reasonable level of accuracy. The volume of data across the necessary number of channels is too great. As a human population, we create 2.5 quintillion bytes of data per day, and language being the primary mode of communication, drastically shifts over time based on historical events, politics, new experiences, etc.

The highlighting 411 can take many forms: displaying the high-frequency word with bold text (see e.g., 411 “HIGH-FREQUENCY”; changing the color of the high-frequency word (see e.g., 411, “HIGHLIGHTED”; creating a highlight on the background adjacent to the high-frequency word (see e.g., 411, “GRAMMATICAL”; and italicizing the high-frequency word (see e.g., 411, “PARETO”, inter alia.

The programmatic implementation 301 processes and tracks 451 the user interaction with the captured 410 and highlighted 411 content, calculating success rates and exposure 412. The user's success rates and exposure 412 are processed 452 and shown to the user through the UI, UX 413. The user success rates 412 are processed 453 with a machine-learning algorithm via natural language processing (“NLP”) 414, freeing the user from the task of checking their success rates and proficiency. In some embodiments, a binary indication (e.g., correct or incorrect) of accuracy is determined by the system. As such, the correct indications are divided by the total number of responses (correct and incorrect) to arrive at a success rate. Additionally, or alternatively, one or more machine learning algorithms are trained to track and calculate incorrect items and calculate a lack of success rate. For example, training includes inputting a top 1000 most used word list (per language) into the model, that is aggregated from a plurality of sources (e.g., dictionary, Urban dictionary for slang words, Google trends to determine what people are searching for, social media feeds, etc.). The model may automatically update over time, for example every six months, to include new words that are added to the top 1000 most used word list for the target language. Such new words may be identified by automatically comparing a first list to a second list or a future list and identifying words that are duplicates between the two lists. Over time, the machine learning model increases words and/or phrases that it can identify. Further, the Such tracking includes identifying a type of word (e.g., noun, verb, adjective, etc.) that was identified incorrectly. The machine learning model then automatically takes these incorrect outputs and automatically feeds them back into the model (autonomously trains itself) to further train the model to identify or predict types of words that the learner may get incorrect in the future. As a result, the self-trained machine learning model outputs words of the same type that the learner got incorrect, for example at an increased frequency, to increase the learner proficiency for those types of words

Further, in some embodiments, a learner is presented with a phrase in base language and they have to speak it back to the application (e.g., using a microphone of the computing device). The analytics module is configured to identify the spoken language and score it based on how accurately it was spoken relative to how a native speaker may hear it. Such features of the analytics module may be employed using one or more machine learning models trained on language characterstics like tonality, pace, etc. for languages and regions. This feature is especially important for tonal languages like Mandarin and Cantonese.

The processed success rates 414 are fed to a module 454 of the programmatic implementation 301 that adjusts 415 the captured content 410 that is presented to the user 411 based off of the user's progress 413. The content adjusting 415 can take one of two implementations 455, 456. The exposure rate of high-frequency words and phrases to the user 113 can be increased or decreased based off the success rate 416. The new exposure rate 416 can then be fed back 481 to the captured content 410. The highlighting of high-frequency words and phrases can also be modified to emphasize certain content to the user 417. The new highlighting scheme 417 can be fed back 480 to the captured content 410.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on the server and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “language” may include, and is contemplated to include, a plurality of languages. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented language learning method comprising
receiving a recorded conversation, which complies with a guideline document, between at least two individuals fluent in the target language, wherein the individuals in the recorded conversation are referred to as Native-speakers, and wherein the guideline document contains unscripted conversation topics in a target language, without reference to specific words or phrases;
wherein the recorded conversation is comprised of a plurality of non-trivial words and phrases; and
wherein the non-trivial words are those that give meaning to the recorded conversation;
transcribing, using a first one or more application program interfaces, the recorded conversation in the target language;
translating, using a second one or more application program interfaces, the recorded conversation into a base language;
segmenting, using a combination of time-stamp metadata and a natural language processing text segmentation algorithm, the transcribed and translated versions of the recorded conversation, into snippets, so that each snippet is composed of a logical block of language of the recorded conversation, lasting about thirty seconds to about five minutes in duration and containing a plurality of non-trivial words and phrases, and
wherein the snippet is comprised of the logical block of language from the recorded conversation, the transcribed text in the target language corresponding to the logical block of language from the recorded conversation, and the translated text in the base language corresponding to the logical block of language from the recorded conversation;
creating a target language concordance of the recorded conversation comprising:
generating an alphabetical listing, using a sort-function algorithm, of the non-trivial words and phrases of the target language contained in the recorded conversation, and
generating a key-value collection in which each key represents a word or a phrase in the alphabetical listing and each value represents one or more references to locations in one or more segments in which the word or phrase occurred within the recorded conversation, the transcribed text, and the translated text;
generating a Pareto distribution from the concordance,
wherein the Pareto distribution identifies the frequency with which the non-trivial words and phrases appear in the recorded conversation;
wherein the non-trivial words and phrases are rank ordered in terms of frequency of occurrence;
wherein a frequency threshold is defined for the Pareto distribution; and
wherein the words appearing more often than the frequency threshold are referred to as high-frequency words and phrases;
analyzing the snippets, using the Pareto distribution and concordance, to ascertain the snippets within which the high-frequency words and phrases occur most frequently; and
presenting the snippets, within which the high-frequency words and phrases occur most frequently, on a graphical user interface of a computing device of a student fluent in the base language but not the target language.

2. The language learning method of claim 1, further comprising logging per API accuracy statistics for the one or more APIs for transcription that are then used to train one or more machine learning models to select a most effective API for future transcription to continuously improve transcription accuracy over time.

3. The language learning method of claim 1, further comprising merging the target language concordance for the recorded conversation with a broader concordance for an entire target language dataset to account for conversational bias on a per recorded conversation basis.

4. The language learning method of claim 1, wherein one or both of the target language and the base language is exactly one of the 26 Most Spoken Languages as defined by the 2017 edition of ETHNOLOGUE: LANGUAGES OF THE WORLD, published by SIL International.

5. The language learning method of claim 1, wherein the high-frequency words and phrases are highlighted on the graphical user interface during language learning activities.

6. The language learning method of claim 5, wherein highlighting occurs by making high-frequency words and phrases one or more of: bold, italicized, a different color than the rest of the text, or a different color than the background for the rest of the text.

7. The language learning method of claim 1, wherein the frequency threshold for the high-frequency words is based on a countable number of non-trivial words.

8. The language learning method of claim 7, wherein the frequency threshold is one of: less than five hundred words; exactly five hundred words; or more than five hundred words but less than one thousand words.

9. The language learning method of claim 7, wherein the frequency threshold for the high-frequency words is based on a percentage of non-trivial words.

10. The language learning method of claim 9, wherein the frequency threshold is one of: less than 10%; exactly 10%; or more than 10% but less than 25%.

11. The language learning method of claim 1, wherein all of the snippets are between about one minute and about three minutes in duration.

12. A language learning system comprising:
at least one user electronic device, comprising a processor, a memory element that has a first non-transitory computer readable medium, a graphical user interface communicatively coupled to the processor, and a transceiver allowing the at least one user device to send and receive information;
a server comprising a server memory element that has a second non-transitory computer readable medium, a server processor, and a server transceiver, wherein the server is communicatively coupled to the at least one user electronic device;
at least one computer readable instruction set, called an application, configured to run on one or both of the at least one user electronic device or the server, such that one or both of the processor or the server processor is configured to execute the instruction set comprising:
receiving a recorded conversation, which complies with a guideline document, between at least two individuals fluent in the target language, wherein the individuals in the recorded conversation are referred to as Native-speakers, and wherein the guideline document contains unscripted conversation topics in a target language, without reference to specific words or phrases;
wherein the recorded conversation is comprised of a plurality of non-trivial words and phrases; and
wherein the non-trivial words are those that give meaning to the recorded conversation;
transcribing, using a first one or more application program interfaces, the recorded conversation in the target language;
translating, using a second one or more application program interfaces, the recorded conversation into a base language;
segmenting, using a combination of time-stamp metadata and a natural language processing text segmentation algorithm, the transcribed and translated versions of the recorded conversation, into snippets, so that each snippet is composed of a logical block of language of the recorded conversation, lasting about thirty seconds to about five minutes in duration and containing a plurality of non-trivial words and phrases, and
wherein the snippet is comprised of the logical block of language from the recorded conversation, the transcribed text in the target language corresponding to the logical block of language from the recorded conversation, and the translated text in the base language corresponding to the logical block of language from the recorded conversation;
creating a target language concordance of the recorded conversation comprising:
generating an alphabetical listing, using a sort-function algorithm, of the non-trivial words and phrases of the target language contained in the recorded conversation, and
generating a key-value collection in which each key represents a word or a phrase in the alphabetical listing and each value represents one or more references to locations in one or more segments in which the word or phrase occurred within the recorded conversation, the transcribed text, and the translated text;
generating a Pareto distribution from the concordance,
wherein the Pareto distribution identifies the frequency with which the non-trivial words and phrases appear in the recorded conversation;
wherein the non-trivial words and phrases are rank ordered in terms of frequency of occurrence;
wherein a frequency threshold is defined for the Pareto distribution; and
wherein the words appearing more often than the frequency threshold are referred to as high-frequency words and phrases;
analyzing the snippets, using the Pareto distribution and concordance, to ascertain the snippets within which the high-frequency words and phrases occur most frequently; and
presenting the snippets, within which the high-frequency words and phrases occur most frequently, on the graphical user interface of the at least one user electronic device of a student fluent in the base language but not the target language.

13. The language learning system of claim 12, wherein the user electronic device is one of: a cellphone, a computer, a tablet, or a wearable piece of electronics.

14. The language learning system of claim 12, wherein the at least one application is resident on the server.

15. The language learning system of claim 12, wherein the at least one application is resident on the user's electronic device.

16. The language learning system of claim 12, wherein the application on the server and the application on the user's electronic device interact over a communications network.

17. The language learning system of claim 16, wherein the communications network is a cellular network, the internet, or a hybrid thereof.

18. The language learning system of claim 17, wherein the server is a cloud server that is a vendorized server available over the internet.

19. The language learning system of claim 12, wherein the application is presented as a series of web pages.

20. The language learning system of claim 19, wherein the user's electronic device is configured to access the web pages of the application.
